(19) United States
(12) Patent Application Publication
(10) Pub. No.: US 2018/0257523 A1
(43) Pub. Date: Sep. 13, 2018

(54) Motor Vehicle Seat And Method For Managing The Comfort Of Such A Motor Vehicle Seat

(71) Applicant: Faurecia Sieges d'Automobile, Nanterre (FR)

(72) Inventors: Anne Isabelle Dacosta-Mallet, Etrechy (FR); Radouane Boussetta, Issy les Moulineaux (FR); Kai Pan, Nanterre (FR); Emmanuelle Brunet, Nanterre (FR)

(73) Assignee: Faurecia Sieges d'Automobile, Nanterre (FR)

(21) Appl. No.: 15/758,598

(22) PCT Filed: Sep. 4, 2014
(86) PCT No.: PCT/FR2014/052187

§ 371 Date: Mar. 12, 2018

(30) Foreign Application Priority Data
Sep. 9, 2013 (FR) 1358631

(51) Int. Cl. B60N 2/56

(52) U.S. Cl. CPC B60N 2/5628; B60N 2/565; B60N 2/5657; B60N 2/5685

(57) ABSTRACT

The present invention concerns a motor vehicle seat comprising a plurality of individualised surface areas of the seat, air-conditioning means, and at least one temperature and/or humidity level sensor. The air-conditioning means and the temperature and/or humidity level sensor are disposed in the individualised surface areas of the seat and the air-conditioning means of each area are controlled to adapt the strength of the heating, cooling and ventilation independently in each area, depending on a local temperature and humidity state determined in each area from the measurements made by the sensors.

The present patent application claims priority from French patent application FR13/58631, which will be considered an integral part of this description.

The present description relates, in general, to seats for motor vehicles, particularly cars, buses, trucks, etc., but also for trains, aircraft, etc.

It particularly relates to a seat comprising climate control means and at least one temperature and/or humidity level sensor. The present invention also relates to managing the climate control means to ensure optimum comfort of a seat occupant, particularly optimal hygrothermal comfort.

In order to improve the comfort of the vehicle occupant, seats having ventilating and heating means have already been proposed, arranged to provide heating or ventilation at the seat surface with which the seat occupant is in contact. Also known are seats having temperature or humidity level sensors arranged on the surface or near the surface of the seat, for controlling the climate control means located in the seat, or more generally in the vehicle. Such seats are known in particular from documents U.S. Pat. No. 5,934,748, US-A-2003/039295, or U.S. Pat. No. 6,892,807.

However, the known devices operate by considering a temperature and a humidity level which are measured at one point of the seat, and act on heating or air conditioning means affecting the entire seat or the entire seating portion or backrest, or on only an area of these.

In other words, there is no possibility of monitoring and adjusting the temperature and/or humidity independently in different areas of the seat and according to the local state of the body of the seat occupant in these different areas, for example at the lumbar support or shoulder area.

This leads for example, as indicated above, to compensating for a general cooling, which may locally excessive, by localized heating.

The present invention seeks to overcome these problems and provide better seat comfort, particularly better hygrothermal seat comfort, by providing better control of the temperature and humidity in the various areas of the seat independently of each other, based in particular on the general state (temperature, humidity) of the vehicle and the local state of both the seat and its occupant, with regards to the respective temperature and humidity levels as well as the position of the occupant on the seat. It also aims to reduce the energy consumption of the heating, ventilation, and air conditioning means by consuming only the energy required to ensure the desired comfort conditions at each seat area.

With these objectives in mind, an object of the invention is a motor vehicle seat comprising
multiple individualized surface areas of the seat,
climate control means, comprising in particular heating means and/or ventilation means and/or air conditioning means, adapted to adjust the temperature and humidity at or near the active area of the seat,
at least one temperature and/or humidity level sensor, in particular arranged at or near the seat surface, for measuring the temperature and the humidity at or near the seat surface and/or passenger compartment,
   characterized in that the climate control means and the temperature and/or humidity level sensor are arranged in the individualized surface areas of the seat.

According to some specific arrangements:
the individualized surface areas of the seat respectively correspond to different parts of the body of an occupant;
the seat further comprises seat padding, and the climate control means comprise at least one ventilation means, in particular a fan, arranged in the seat padding;
the seat further comprises a seat cover covering the seat padding, and a foam layer is arranged between the seat padding and the seat cover;
the temperature and/or humidity level sensor is arranged beneath the seat cover, preferably in direct proximity to a seat surface and/or climate control means;
the temperature and/or humidity level sensor is arranged directly above the ventilation means, in particular the fan;
the climate control means comprise at least one heating means and/or one air conditioning means;
the heating means and/or the air conditioning means comprise active components suitable for supplying heat and/or cold
the active components are located directly above the ventilation means;
the heating means and/or air conditioning means are at a distance from the seat and/or are connected to a climate control system of the vehicle;
the seat comprises a control unit for controlling the climate control means on the basis of values measured by the temperature and/or humidity level sensor;
the control unit is also connected to at least one temperature and/or humidity level sensor arranged within the passenger compartment and/or outside the passenger compartment;
the seat comprises at least one pressure sensor arranged in the individualized surface areas of the seat.

The invention also relates to a method for managing the comfort, in particular to ensure better hygrothermal comfort, of a motor vehicle seat as defined above, having climate control means, in particular comprising heating means and/or ventilation means and/or air conditioning means adapted for adjusting the temperature and humidity at or near the active area of the seat, temperature and humidity level sensors arranged at or near the seat surface for measuring the temperature and humidity at or near the seat surface, and a control unit for controlling the climate control means on the basis of the measurements obtained by the sensors. In the invention, the method is characterized in that the climate control means of each individualized surface area of the seat are controlled so as to independently adjust the intensity of the heating, air conditioning, and/or ventilation, on the basis of a local state of the temperature and/or humidity level determined in each individualized surface area of the seat from the measurements made by the temperature and/or humidity level sensor.

One will note that “active area of the seat” is understood to mean the related surface of the seat with which the user comes into contact, both seating portion and backrest, as well as nearby surfaces such as side bolsters, etc.

The temperature and humidity level sensors thus enable detecting an increase in temperature or humidity indicative of the arrival and then the presence of a seat occupant. In addition, they allow detecting and quantifying a humidity state in direct proximity to the seat surface, for example resulting from a greater or lesser degree of sweating by the occupant. In addition, due to the distribution of sensors in different surface areas of the seat, and to the individualization of the measurements obtained for each area by these various sensors, it is possible to determine a temperature and humidity state in each surface area, and to control the climate control means of each area independently on the basis of the values supplied by the sensors, so as to assist the occupant in finding and maintaining a temperature and humidity state that provides the occupant with a feeling of optimum comfort. One can thus control the intensity of the heating or air conditioning, as well as the ventilation, independently for each area. For example, one may wish to compensate locally for excessive sweating in certain parts of the user's body, for example in the lumbar area, by increasing the ventilation at a temperature that is not too low, while taking into account the various heating and/or ventilation requirements in other parts of the body, for example the seating portion which the thighs rest against requiring less heat than the backrest which the back rests against.

The proximity between the sensors and climate control means in each area allows more precise and more responsive control of the climate control means according to the information provided by the sensors, in order to restore a state of comfort as quickly as possible, for example when a user already suffering from heat takes a seat in a car where the passenger compartment is already at a high temperature, and to subsequently maintain this state of comfort by adjusting the climate control for the seat according to changes in the temperature and humidity state of the seat and its occupant.

According to an additional arrangement, the climate control means are controlled on the basis of the intensity of the contact of the occupant with the seat and/or with at least certain contact surfaces of the seat.

Indeed, as previously stated, the temperature and humidity level sensors can provide an indication of the presence of the body of a user, and pressure sensors can supplement this information. This presence indication, or pressure intensity, obtained locally in each area, also provides additional information about the morphology of the user and the user's position in the seat, and can also serve as an input parameter for controlling the climate control means in each area of the seat, based on the morphology of the user and the user's position.

Another important advantage of the invention is that, due to the individualized control of the climate control means in each area, it allows minimizing the consumption of energy required to operate these means. Only the heating, ventilation, or air conditioning means which are locally needed are used, and areas that do not require the use of these means do not consume any energy. These energy savings will be boosted by the possibility of locally fine-tuning the intensity of the heating or cooling, or the power delivered by the fans.

The invention therefore quickly provides the best possible state of comfort when the user sits down on the seat, and subsequently maintains that comfort according to the temperature and humidity conditions of the user, the seat, and even of the vehicle as a whole, while minimizing the energy consumption required to achieve this comfort.

The climate control means and more particularly the intensity of the ventilation and heating or air conditioning may be controlled on the basis of predefined temperature and humidity ranges. These temperature and humidity value ranges are determined experimentally, each range being considered representative of a temperature and humidity state at the seat surface, correlated with the presence of an occupant on the seat and with the temperature and humidity state of said occupant, which allows determining the actions to be taken in terms of heating, ventilation, and air conditioning, based on the measured temperature and humidity values and the predefined ranges containing these values.

The climate control means may also be controlled on the basis of predefined temperature and/or humidity trigger threshold values.

In one particular arrangement, the intensity of the ventilation and heating or air Conditioning in each area may also be controlled on the basis of variations in the temperature and/or humidity of at least one of the individualized surface areas of the seat. In other words, the algorithm used for managing the various climate control means will take into account not only the instantaneous values of temperature and humidity, or average values over predefined periods, but the direction of change and rate of change of these values. From these data, the algorithm can determine typical situations of comfort or discomfort, and can act on the heating or air conditioning and on the intensity of the ventilation, in order to return the seat to a state of comfort as soon as possible and then to maintain it.

According to an additional arrangement, the intensity of the ventilation and heating or air conditioning may also be controlled in each area on the basis of the temperature and/or humidity level values measured in other individualized surface areas of the seat, and/or on the basis of the intensity of the heating, air conditioning, and/or ventilation in other individualized surface areas of the seat. These additional parameters allow taking one or more areas into account in the control of the climate control means, as well as the situation in neighboring areas, which in particular can help to ensure a degree of progressivity in the effect of the climate control means of neighboring areas, for example to prevent the occupant from feeling a sensation of strong refreshing ventilation in one area and no ventilation in an adjacent area.

Preferably, the intensity of the ventilation and heating or air conditioning in each area of the seat may also be controlled on the basis of the value of at least the temperature and/or humidity level, measured in the passenger compartment of the vehicle. Climate control for the seat will then be carried out while also taking into account the ambient temperature and humidity, in order to provide a general feeling of comfort.

As we can see, the method according to the invention can thus implement different algorithms, adapted to the number of areas defined on the seat surface and managed by the control unit, but also to the general environment within the passenger compartment and its occupied state.

For example, the climate control for a seat can be managed independently for each seat of the vehicle, and if the set of values supplied to the processor by the various sensors leads to a determination that a seat is vacant, all climate control means for that particular seat can be turned off even if the temperature within the vehicle is too high overall. However, in case of excessively high temperatures, refreshing ventilation may possibly be turned on for this vacant seat in order to supplement the general climate control for the passenger compartment.

As noted above, the climate control means for a seat may be controlled not only on the basis of the sensors equipping said seat but also on the basis of environmental sensors for the passenger compartment. Climate control management for a seat may be individualized, or climate control for all the climate controlled seats of a vehicle may be managed in common by a common control unit, and possibly in association with the climate control management for the entire vehicle.

The invention therefore relates to a climate control system for a motor vehicle seat, having climate control means comprising in particular heating means and/or ventilation means and/or air conditioning means adapted to adjust the temperature and humidity at or near the active area of the seat, temperature and humidity sensors arranged at or near the seat surface for measuring the temperature and the humidity at or near the seat surface, and a control unit, connected to the sensors and to the climate control means for operating the climate control means according to signals representative of the measurement values obtained by the sensors. The climate control means and the sensors are arranged in multiple areas of the active area of the seat, and the control unit is arranged to be able to control the climate control means of each area, independently of each other, on the basis of the signals supplied by the sensors.

Typically, the surface of the seating portion and the surface of the backrest are divided into multiple areas which respectively correspond to different parts of the occupant's body. Within each area, the sensors are arranged in proximity to the seat surface, under a seat cover which covers the seat padding, and in direct proximity to the climate control means, which ensures optimal responsiveness in controlling the climate control means according to variations in the values measured by the sensors, directly exposed to the effects of said climate control means.

According to one particular embodiment, the ventilation means comprise fans located in the padding of the seat, the heating and air conditioning means comprise active components for providing heat or cold, located directly above the fans, between the padding and the seat cover and separated from the fans by a porous layer enabling distribution of the blown air, and the sensors are located under the seat cover directly above the fans. The porous layer allows the blown air to be better distributed and allows better and more uniform transfer of the heat or cold over the surface of the area concerned.

The control unit is preferably also connected to temperature and humidity sensors arranged within the passenger compartment and/or outside the passenger compartment, so as to also take into account the temperature and humidity level of the passenger compartment and/or its environment in order to individually manage the climate control for each seat. This arrangement assists the seat user with quickly restoring a general feeling of comfort.

The control unit may thus be specific to each seat, or manage climate control for multiple seats, or be combined or integrated into a control unit managing all climate control for the vehicle. Also, the climate control means may comprise components located at a distance from the seat surface and connected to general climate control means for the vehicle. Thus, some of the climate control means, or at least some components of these means, for example a source of cooling, may be shared between multiple seats, or even with components performing the same function in the general climate control of the vehicle.

According to other specific arrangements:
the active elements of the heating means are electrical resistors or inks of variable resistance,
the air conditioning means comprise Peltier-effect elements,
the temperature sensors may be thermocouples, resistive sensors, or infrared sensors,
the humidity sensors may be resistive or capacitive sensors,
the temperature and humidity may be measured by one sensor shared by both functions,
the seat also comprises pressure sensors distributed in different areas and connected to the control unit,
the fans are arranged to provide air flow between different areas by suctioning air through the seat cover in one area and sending it into a different area. This arrangement can help facilitate the removal of excess moisture. In addition, when air is suctioned through the seat cover, the sensor located under this cover measures the temperature and humidity of the air which has just passed through the cover and which is therefore closer to the actual temperature and humidity level of the user. The measured values are therefore more accurate and representative of the actual state of the temperature and humidity of the user, enabling faster and more effective application of the required correction.

The present invention also relates to the use of blowing systems or a combination of blowing/suctioning systems.

The method according to the invention provides acoustic comfort for the passenger(s). As the method regulates the use of the ventilation means, the passenger does not perceive a constant ambient noise associated with continual use of the ventilation means. This helps reduce passenger fatigue.

Of course, the various features, variants, and/or embodiments of the invention can be associated with one another in various combinations as long as they are not incompatible or mutually exclusive of one another.

The invention will be better understood and other features and advantages will be apparent from reading the following detailed description comprising embodiments provided for illustrative purposes with reference to the accompanying drawings, presented as non-limiting examples, which can serve to enhance the understanding of the invention and the description of its implementation, and contribute to its definition where appropriate, in which:

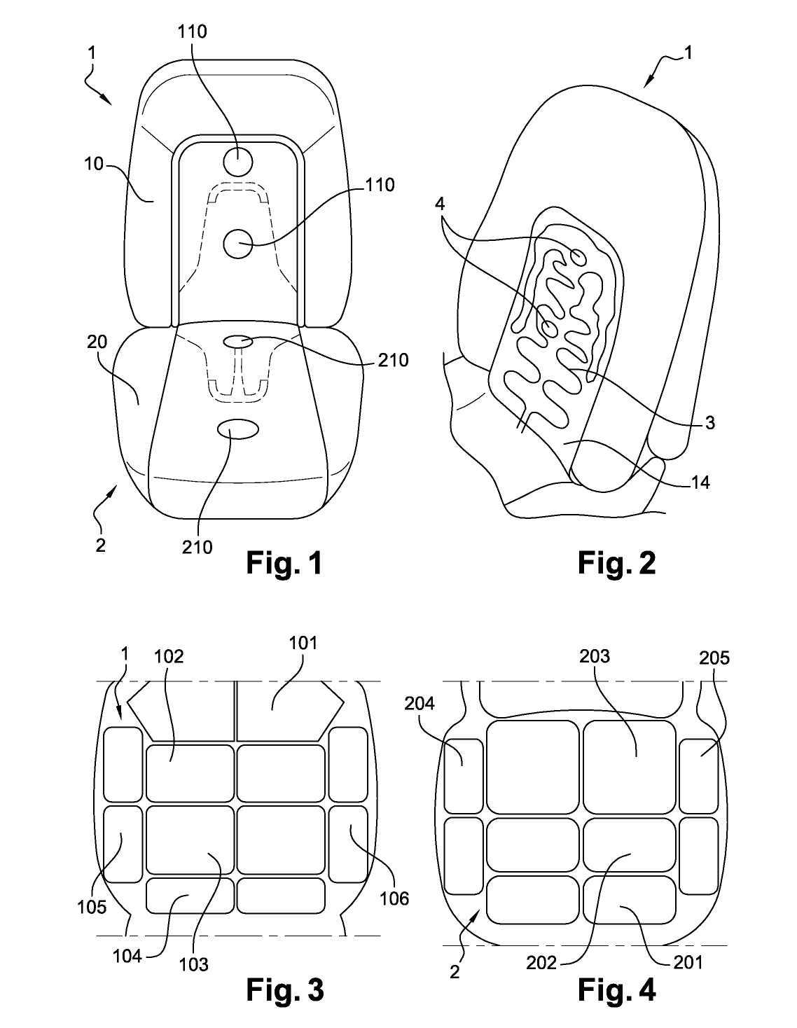

FIG. 1 is a front view of a seat according to the invention,

FIG. 2 is a perspective view of a backrest of the seat of FIG. 1,

FIG. 3 is a schematic representation of an exemplary distribution of the various areas of an exemplary distribution of the backrest of FIG. 2,

FIG. 4 is a schematic representation of an exemplary distribution of the various individualized surface areas of a seating portion of the seat of FIG. 1,

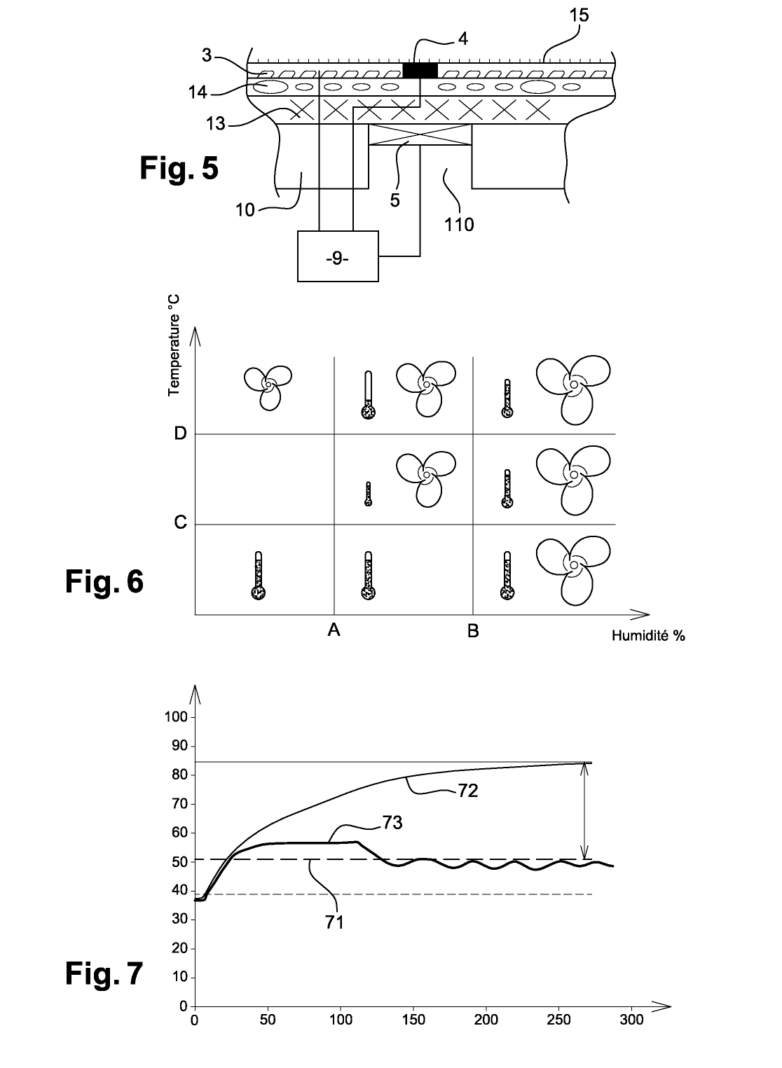

FIG. 5 is a partial sectional view of the seat of FIG. 1,

FIG. 6 illustrates a table showing a control algorithm according to the invention, and

FIG. 7 is a comparative graph illustrating variations in the relative humidity with and without an implementation of the invention.

It should be noted that in the figures, the structural and/or functional elements common to the various embodiments may have the same references. Thus, unless otherwise indicated, such elements have identical structural, dimensional, and material properties.

For clarity, only those elements useful to understanding the described embodiments have been represented and will be detailed. In particular, the implementation of other elements of the seat and vehicle has not been detailed, for example the seat frame, as the embodiments described are compatible with conventional elements.

In the following description, when reference is made to absolute position descriptors such as “front”, “rear”, “top”, “bottom”, “left”, “right”, etc., or relative descriptors such as “above”, “below”, “upper”, “lower”, etc., or orientation descriptors, these are in reference to a seat in its normal position of use in the usual direction of advancement of the vehicle.

We first refer to FIG. 1, which is a front view of a seat according to the invention, comprising at least a backrest 1 and a seating portion 2. FIG. 1 shows a general view of seat padding according to the invention, comprising backrest padding 10 and seating portion padding 20. More specifically, FIG. 1 shows a general view of seat padding in which is positioned at least one heating, ventilation, and/or air conditioning means, in particular in the backrest 1 and/or in the seating portion 2. Advantageously, the backrest padding 19 and/or the seating portion padding 20 are made of polyurethane foam.

The backrest padding 10 and/or the seating portion padding 20 comprises at least one placement site 110, 210, created for the placement of at least one ventilation means 5, in particular a fan 5, for example as shown in FIG. 5 which is a partial sectional view of the seat of FIG. 1. In particular, FIG. 5 illustrates an example arrangement of the various respective components of the heating, ventilation, and/or air conditioning means.

In the embodiment shown in FIG. 1, only two placement sites 110 for fans 5 arranged is the backrest 1 and two sites 210 for fans 5 arranged in the seating portion 2 are represented. However, the number of fans 5 arranged in the backrest 1 and/or in the seating portion 2, and therefore the number of placement sites 110, 210, may vary. For example, more may be provided, in particular one per individualized surface area of the seat, where it will be possible to measure a temperature and a humidity level individually. It is thus possible to control the local ventilation, heating and/or air conditioning in the individualized surface area of the seat. The number of individualized surface areas of the seat may be more than two, as will be described further below.

We now refer to FIG. 2 which is a perspective view of a backrest 1 of the seat of FIG. 1. In the embodiment shown in FIG. 2, the backrest 1 is also provided with sensors and a heater mat.

More generally, in addition to the fans, the seat is provided with heating and/or air conditioning means, and at least one temperature and/or humidity sensor 4, as shown in FIG. 2 where only the backrest 1 has been represented. It is understood that similar means can also equip the seating portion 2.

The backrest 1 shown in FIG. 2, of which FIG. 5 is a partial sectional view showing more detail, comprises, preferably in direct contact with the backrest padding 10, a structural layer 13 with an overlying foam layer 14, preferably a perforated foam layer 14.

Ideally, the backrest 1 comprises a seat cover 15 arranged above the backrest padding 10, more specifically above the structural layer 13 and/or the foam layer 14.

The structural layer 13 is a layer made of a material that allows maintaining an area for air circulation even when the seat is occupied. Advantageously, the structural layer 13 has a low compression level in order to allow air to circulate.

Furthermore, the foam layer 14, in particular the perforated foam layer 14, also allows air to circulate.

Therefore, the assembly consisting of the structural layer 13 and the foam layer 14 allows the passage and distribution of air circulated by the fan(s) 5.

According to the invention, the fan(s) 5 circulate air by suctioning air, blowing air, or combining the suctioning and blowing of air alternately or simultaneously.

In addition, the backrest 1 comprises at least one heating means 3, advantageously consisting of an electrical resistor 3. The heating means 3 is preferably placed above the foam layer 14. More specifically, the heating means 3 is placed between the foam layer 14 and the seat cover 15.

The backrest 1 may comprise at least one air conditioning means, not shown, arranged in the seat.

The assembly of the heating means 3 and/or air conditioning means is covered by the seat cover 15, which for example is made of perforated leather.

Within the meaning of the invention, the assembly comprising the heating means 3 and/or air conditioning means and/or ventilation means 5 constitutes the climate control means, also referred to as heating, ventilation, and/or air conditioning means.

According to the present invention, the temperature and/or humidity sensor 4, here represented as one shared sensor 4, for example a “Sensirion®” sensor, is preferably placed between the foam layer 14 and the seat cover 15. Such an arrangement allows placing the temperature and/or humidity sensor 4 closer to the surface of the seat and therefore to a seat occupant.

The temperature and/or humidity sensor 4 and the climate control means are connected to a control unit 9.

According to an exemplary embodiment, the temperature and/or humidity sensor 4 is substantially aligned with the fan 5, meaning substantially in front of the fan 5. Such an arrangement ensures greater responsiveness to the effects of the climate control means for the individualized surface area of the seat.

Preferably, the seat comprises a plurality of individualized surface areas of the seat having respectively at least one fan 5 and at least one temperature and/or humidity sensor 4. According to this particular arrangement, the fans 5 are advantageously controlled separately on the basis of the values measured by the temperature and/or humidity sensors 4 and/or on the basis of reference values.

Similarly, the heating means 3 and/or air conditioning means are also controlled, preferably independently, on the basis of the values measured by the temperature and/or humidity sensors 4 and/or on the basis of reference values.

Other sensors may be located for example under the seat, or elsewhere in a passenger compartment where the seat is installed, to measure the temperature and/or humidity of the ambient air of the passenger compartment. It is also possible to place sensors to measure the temperature and/or humidity of the air outside the passenger compartment.

As shown in FIG. 3 which is a schematic representation of an exemplary distribution of various individualized surface areas of the seat of the backrest 1 of FIG. 2, the surface of the backrest 1 is divided into several individualized surface areas of the seat, for which the temperature and/or humidity can be individually adjusted.

Each individualized surface area of the seat of the backrest 1 is provided with at least one temperature and/or humidity sensor 4 and can be ventilated, heated, and/or cooled independently of other individualized surface areas of the seat, by the specific climate control means mentioned above.

Thus, according to the example of FIG. 3, the backrest 1 comprises from top to bottom in a vertical direction:
at least one upper area 101, which advantageously corresponds to an area supporting the shoulders of the seat occupant,
at least one intermediate area, which advantageously corresponds to an area supporting the torso of the seat occupant, and
at least one lower area 104, which advantageously corresponds to an area at the pelvis of the seat occupant.

Preferably, the intermediate area comprises a first intermediate area 102, which advantageously corresponds to an area at the upper torso of the seat occupant, and a second intermediate area 103, which corresponds to an area supporting the lumbar region of the seat occupant.

In addition, the backrest 1 may comprise at least one lateral area 105, 106, preferably two lateral areas 105, 106 arranged on each side of the backrest 1. The lateral areas 105, 106 correspond to the side bolsters of the backrest 1.

Similarly, as shown in FIG. 4 which a schematic representation of an exemplary distribution of the various individualized surface areas of the seat of the seating portion 2 of the seat of FIG. 1, the surface of the seating portion 2 is divided into several individualized surface areas of the seat, for which the temperature and/or humidity can be adjusted individually.

Each individualized surface area of the seat of the seating portion 2 is provided with at least one temperature and/or humidity sensor 4 and can be ventilated, heated, and/or cooled independently of other individualized surface areas of the seat, by specific climate control means as mentioned above.

Thus, according to the example of FIG. 4, the seating portion 2 comprises, longitudinally from front to rear:
at least one front area 201, which advantageously corresponds to an area located at the top front of the seating portion of the seat,
at least one intermediate area 202, which advantageously corresponds to the area supporting the thighs of the seat occupant, and
at least one rear area 203, which advantageously corresponds to an area supporting the buttocks of the seat occupant.

In addition, the seat 2 may comprise at least one lateral area 204, 205, preferably two lateral areas 204, 205, arranged on each side. The lateral areas 204, 205 correspond to the side bolsters of the seat 2.

In the invention, each of the previously identified individualized surface areas of the seat can be subdivided in a transverse direction of the seat, in order to define a symmetrical distribution with respect to a center plane of the seat.

In addition to the temperature and/or humidity sensor(s) 4, the seat may be provided with at least one pressure sensor, not shown, for detecting the presence of the occupant.

It is possible to use a single pressure sensor, located for example in the seating portion. It is also possible to have multiple pressure sensors distributed in different locations of the seat, in order to better identify the position of the occupant in the seat.

The pressure sensors can supplement the position detection performed by means of the temperature and/or humidity sensors 4, it then being assumed that local detection of an increase in temperature and/or humidity in areas where the applied pressure is predominant is an indication that the occupant is present.

Note that the ability to thus detect contact with the seat occupant, individually at various locations of the seat or at least at certain locations of the seat, for example the rear area 203 of the seating portion 2 or the lower area 104 of the backrest 1, provides an indication that the occupant is present and/or an indication of the position of the occupant, for example with erect posture or slouched.

Such indications make it possible to control the climate control means according to various rules forming a control algorithm, preferably integrated with the control unit 9. The control unit 9 is, for example, an electronic control device comprising an electronic control circuit.

For example:
if there is no seat occupant, in principle there is no need to make use of the climate control means of the
if the occupant is not in contact with the upper area 101 of the backrest 1, there is no need to make use of the climate control means dedicated to the upper area 101 of the backrest 1 in order to heat, cool, and/or ventilate the upper area 101 of the backrest 1, in particular to eliminate moisture;
. . .

Moreover,
if the value of the humidity level, in particular as measured by the temperature and/or humidity sensor 4, changes rapidly, for example a variation of 50% within a short time, for example 1 second, then stabilizes between two predetermined values A and B, such a variation in the humidity level can be considered to be the result of the arrival of a seat occupant in a state considered to be standard;
if the humidity continues to rise beyond the predetermined value B, this can be considered to be the result of sweating by the seat occupant, and there is then a need to activate the climate control means of the seat in order to adapt to this specific situation;
. . .

The rules detailed above are of course given only as examples and can of course be modified. Many other rules can be taken into consideration in the algorithm for controlling the climate control means, as we shall see below.

Through the use of multiple temperature and/or humidity sensors 4 and/or pressure sensors in adjacent individualized surface areas of the seat, the values obtained by the various temperature and/or humidity sensors 4 and/or pressure sensors can be compared, in particular to one another, to nominal values, and/or to reference values. If a significant difference is observed, the climate control means, in particular the specific climate control means of an individualized surface area of the seat, can be controlled according to specific needs.

For example, if the temperature and/or humidity sensor 4 arranged in the upper area 101 of the backrest 1 measures less humidity, for example about 10%, than the temperature and/or humidity sensor 4 arranged in the second intermediate area 103 at the lumbar region, the specific climate control means of the second intermediate area 103 are then activated.

FIG. 6 illustrates a table showing a control algorithm according to the invention. More particularly, FIG. 6 shows an example of managing the climate control means in predetermined ranges of temperature and humidity values, the humidity being plotted on the horizontal axis and the temperature on the vertical axis.

As presented in FIG. 6, the following are defined:
a first humidity threshold A,
a second humidity threshold B, greater than the first humidity threshold A,
a first temperature threshold C, and
a second temperature threshold D, greater than the first temperature threshold C.

As an example, let us consider an ambient temperature of 23° C. and a humidity of 50% as reference values.

Preferably, the first humidity threshold A, the second humidity threshold B, the first temperature threshold C, and the second temperature threshold D, as shown in FIG. 6, can be adjusted automatically by the algorithm on the basis of the ambient temperature and/or ambient humidity in the passenger compartment.

In the table of FIG. 6, use of the heating and/or cooling means is expressed by a thermometer. Similarly, use of the ventilation means is expressed by a fan. The size of the thermometers is related to the intensity of the activated heating and/or cooling. Similarly, the size of the fans is related to the intensity of the activated ventilation.

If the ambient temperature is below the first temperature threshold C, set for example at 25° C.:
regardless of the humidity level, the climate control means are activated and regulated to achieve, and maintain a defined seat surface temperature, for example set at 34° C.

If the surface temperature is between the first temperature threshold C and the second temperature threshold D, set for example at 34° C., and:
if the humidity measured by the temperature and/or humidity sensor 4 is less than the first humidity threshold A, set for example at 40%, the climate control means are not activated;
if the humidity measured by the temperature and/or humidity sensor 4 is greater than the first humidity threshold A in an individualized surface area of the seat, then the climate control means, in particular the specific climate control means of the concerned individualized surface area of the seat, are activated.

Preferably, the climate control means, in particular the specific climate control means of the concerned individualized surface area of the seat, are activated until the humidity returns to a level below the first humidity threshold A, for example a level 10% less than the first humidity threshold A.

If the measured temperature is greater than the second temperature threshold D:
regardless of the humidity level, the ventilation means 5 are activated;
as a supplement, if the humidity level is less than the second humidity threshold B, the air conditioning means are activated.

If the humidity level is higher than the second humidity threshold B:
regardless of the temperature, the ventilation means 5 are activated.

Optionally, if the humidity level is greater than the second humidity threshold B and if the humidity level is less than the second humidity threshold B, the air conditioning means and/or the heating means are successively and/or alternately activated.

The speed of the ventilation means 5 and the strength of the heating and/or cooling are adjusted, preferably in real time, according to the ambient temperature, and the temperature and humidity measured by the temperature and/or humidity sensor 4 in the individualized surface area of the seat.

For example, if the humidity level in the seating portion 2 is high relative to the ambient humidity level, the speed of the ventilation means 5 will be raised in other to quickly lower the humidity, without necessarily being accompanied by heating if the ambient air is already warm. On the other hand, if the humidity level is high at the seat surface and in the air, then the heating and ventilation will be controlled to reach an optimal high level.

When the values supplied by the temperature and/or humidity sensor 4 lead to inferring that the occupant is reasonably comfortable, in particular at a comfortable temperature and humidity level, the climate control means are stopped, preferably automatically.

FIG. 7 is a comparative graph illustrating the variation in relative humidity with and without implementation of the invention. More particularly, the graph of FIG. 7 shows an example of the variation in the humidity level over time.

The graph of FIG. 7 includes:
a first curve 71, representing the ambient humidity
a second curve 72, representing the variation in humidity when an occupant sits down on the seat, without regulation according to the invention
a third curve 73, representing the variation in humidity in the seat with regulation according to the invention.

It can be seen that implementing the regulation of climate control means of the seat according to the invention allows quickly reaching and then maintaining an optimal humidity level, which can be considered to be a humidity level that is comfortable for the seat occupant.

The slopes of the temperature and humidity curves can be used to identify whether one is:
in a dynamic state, when the occupant sits down on the seat, or
in a stable state, with the occupant remaining in place on the seat,

and the climate control means of the seat can be controlled accordingly.

Generally, due to the arrangement of multiple temperature and/or humidity sensors 4 and/or multiple pressure sensors in different individualized surface areas of the backrest 1 and/or of the seating portion 2, it is possible to create, in real time, a map of the temperature and humidity levels at the surface of the seat. This allows controlling the climate control means of the seat, particularly the specific climate control means of the seat, so as to ensure the hygrothermal comfort of the occupant. Moreover, it is possible to define a rule for differentiating between different individualized surface areas of the backrest 1 and/or of the seating portion 2. For example, such a differentiating rule can specify that the backrest 1 is to be more heated than the seating portion 2, and that the temperature experienced over the entire surface of the seat is to be uniform.

Preferably, control is automatic via the algorithm of the control unit. However, as an addition, a manual control mode is also possible.

The invention obviously not limited to the embodiments described above and provided only as examples. It encompasses various modifications, alternative forms, and other variants that are conceivable to the skilled person within the context of the invention, including any combination of the different modes of operation described above, taken separately or in combination.

1. A motor vehicle seat comprising
multiple individualized surface areas of the seat,
climate control means;
at least one temperature and/or humidity level sensor, characterized in that the climate control means and the temperature and/or humidity level sensor are arranged in the individualized surface areas of the seat.

2. The seat according to claim 1, wherein the individualized surface areas of the seat respectively correspond to different parts of the body of an occupant.

3. The seat according to claim 1, further comprising seat padding, wherein the climate control means comprise at least one ventilation means, in particular a fan, arranged in the seat padding.

4. The seat according to claim 3, further comprising a seat cover covering the seat padding, wherein a foam layer is arranged between the seat padding and the seat cover.

5. The seat according to claim 3, wherein the temperature and/or humidity level sensor is arranged beneath the seat cover, preferably in direct proximity to a seat surface and/or climate control means.

6. The seat according to claim 3, wherein the temperature and/or humidity level sensor is arranged directly above the ventilation means, in particular the fan.

7. The seat according to claim 1, wherein the climate control means comprise at least one heating means and/or one air conditioning means.

8. The seat according to claim 7, wherein the heating means and/or the air conditioning means comprise active components suitable for supplying heat and/or cold.

9. The seat according to claim 8, wherein the active components are located directly above the ventilation means.

10. The seat according to claim 1, wherein the heating means and/or air conditioning means are at a distance from the seat and/or are connected to a climate control system of the vehicle.

11. The seat according to claim 1, comprising a control unit for controlling the climate control means on the basis of values measured by the temperature and/or humidity level sensor.

12. The seat according to claim 11, wherein the control unit is also connected to at least one temperature and/or humidity level sensor arranged within the passenger compartment.

13. The seat according to claim 1, comprising at least one pressure sensor arranged in the individualized surface areas of the seat.

14. A method for managing the comfort, particularly the hygrothermal comfort, of a motor vehicle seat according to any one of the preceding claims, characterized in that the climate control means of each individualized surface area of the seat are controlled so as to independently adjust the intensity of the heating, air conditioning, and/or ventilation, on the basis of a local state of the temperature and/or humidity level determined in each individualized surface area of the seat from the measurements made by the temperature and/or humidity level sensor.

15. The method according to claim 14, wherein the climate control means are controlled on the basis of the intensity of the contact of the occupant with
the seat and/or
at least certain contact surfaces of the seat.

16. The method according to claim 14, wherein the climate control means are controlled on the basis of predetermined ranges of temperature and/or humidity level.

17. The method according to claim 14, wherein the climate control means are controlled on the basis of predefined temperature and/or humidity trigger thresholds.

18. The method according to claim 14, wherein the climate control means are controlled on the basis of variations in the temperature and/or humidity level of at least one of the individualized surface areas of the seat.

19. The method according to claim 14, wherein the climate control means are controlled on the basis of temperature and/or humidity level values measured in other individualized surface areas of the seat and/or on the basis of the intensity of the heating, air conditioning, and/or ventilation in other individualized surface areas of the seat.

20. The method according to claim 14, wherein the climate control means are controlled on the basis of at least the value of the temperature and/or humidity level measured in the passenger compartment of the vehicle.
